(19) United States
(12) Patent Application Publication
(10) Pub. No.: US 2017/0003225 A1
(43) Pub. Date: Jan. 5, 2017

(54) METHOD FOR INVESTIGATING A SAMPLE USING CARS MICROSCOPY

(71) Applicant: LEICA MICROSYSTEMS CMS GMBH, Wetzlar (DE)

(72) Inventor: Bernd SÄGMÜLLER, Laudenbach (DE)

(21) Appl. No.: 15/039,883

(22) PCT Filed: Nov. 28, 2014
(86) PCT No.: PCT/EP2014/075901

§ 371 Date: May 27, 2016

(30) Foreign Application Priority Data
Nov. 28, 2013 (DE) 10 2013 224 412.6

(51) Int. Cl. G01N 21/65

(52) U.S. Cl. CPC G01N 21/65; G01N 2021/653; G01N 2201/06113

(57) ABSTRACT

A method for investigating a sample (1), derived from a biological source, using CARS microscopy is proposed, in which method a resonance signal generated by coherent anti-Stokes Raman scattering by excitation of at least one resonance site (5) of the sample (1) by means of laser irradiation is sensed in image-producing fashion. The method according to the present invention encompasses furnishing at least one resonance site (5) by means of a bioorthogonal reaction of an intrinsic chemical structure (2) of the sample (1) with at least one reaction partner (3, 6).

### CROSS-REFERENCE TO RELATED APPLICATIONS

The present application is the U.S. national phase of International Application No. PCT/EP2014/075901 filed Nov. 28, 2014, which claims priority of German Application No. 10 2013 224 412.6 filed Nov. 28, 2013, the entirety of which is incorporated herein by reference.

### FIELD OF THE INVENTION

The invention relates to a method for investigating a sample, derived from a biological source, using CARS microscopy, in which method a resonance signal generated by coherent anti-Stokes Raman scattering by excitation of at least one resonance site of the sample by means of laser irradiation is sensed in image-producing fashion.

### BACKGROUND OF THE INVENTION

“Nonlinear Raman spectroscopy” is understood to mean spectroscopic investigation methods that are based on nonlinear Raman scattering of light at solids or gases. The present invention refers to microscopic investigation methods based on coherent anti-Stokes Raman scattering (CARS).

For investigation methods of this kind (also referred to as “CARS microscopy”), two lasers that emit light of different wavelengths (v_{P} and v_{S}, the pump and Stokes light beams), where v_{S} should be tunable, are used to generate a CARS spectrum v_{CARS}: v_{CARS}=2v_{P}−v_{S}, I_{CARS}≈(I_{P})²−I_{S}.

FIG. 2 schematically depicts a term diagram of a CARS transition. If the frequency difference v_{P}−v_{S} matches the frequency difference between two molecular vibration states |1> and |0> in an investigated sample, the CARS signal becomes amplified. Structures of a sample in which different molecular states of this kind occur and are also correspondingly detectable (typically, characteristic chemical bonds) are referred to hereinafter as “resonance sites.” Corresponding structures of a molecule, or molecules in general that contain them, are also referred to as “scatterers.”

The pump light beam and Stokes light beam are coaxially combined for microscopy applications, and are focused together onto the same sample volume. The direction in which the anti-Stokes radiation is emitted is determined from the phase adaptation condition for the underlying four-wave mixing process, as depicted schematically in FIG. 3.

Methods and apparatuses for CARS microscopy are known, for example, from DE 102 43 449 A1 (simultaneously U.S. Pat. No. 7,092,086 B2), which describes a CARS microscope having means for generating a pump light beam and a Stokes light beam that are directable coaxially through a microscope optical system onto a sample, and having a detector for detecting corresponding detected light.

Further physical principles of CARS microscopy may be gathered from current reference works (see e.g. Xie, X.S., et al., Coherent Anti-Stokes Raman Scattering Microscopy, in: J. B. Pawley (ed.), Handbook of Biological Confocal Microscopy, 3rd edition, New York, Springer, 2006).

As compared with conventional or confocal Raman microscopy, in CARS microscopy it is possible in particular to achieve higher detected light yields and better suppression of obtrusive secondary effects. The detected light furthermore can be more easily separated from the illuminating light.

Because, as mentioned, characteristic natural vibrations of the molecules in a sample, or of specific chemical bonds, can be used in CARS microscopy, it allows species-selective imaging that in principle dispenses with further tagging and dyes. With CARS microscopy, molecular structure information about a sample can be obtained with three-dimensional spatial resolution.

CARS microscopy always relies, however, on the presence of corresponding resonance sites in the sample. If resonance sites are absent or if, for structures of interest, the frequency differences of their vibration states are not sufficiently distinguished from those of the surroundings, they cannot be detected. In addition, with known methods for CARS microscopy it is often difficult to suppress the non-resonant background.

Picosecond laser pulses can be used, for example, to manipulate or decrease the non-resonant background, but they require the use of correspondingly complex lasers. Further possibilities for reducing the non-resonant background are so-called “epi-detection” and polarization-sensitive detection. Time-resolved methods are also utilized in this context. A further possibility is to control the phase of the excitation pulses.

The aforesaid methods nevertheless prove to be more or less cumbersome in practice. Selective accentuation of defined structures in a sample can also be desirable in certain cases, but this is not possible in conventional methods for CARS microscopy.

### SUMMARY AND ADVANTAGES OF THE INVENTION

The present invention aims to provide a remedy here, and its object is to furnish a correspondingly improved method for CARS microscopy.

This object is achieved by a method for investigating a sample, derived from a biological source, using CARS microscopy, in which method a resonance signal generated by coherent anti-Stokes Raman scattering by excitation of at least one resonance site of the sample by means of laser irradiation is sensed in image-producing fashion, wherein the method comprises furnishing at least one resonance site by means of a bioorthogonal reaction of an intrinsic chemical structure of the sample with at least one reaction partner.

Preferred embodiments are the subject matter of the description below.

The present invention proceeds from a known method for CARS microscopy. A method of this kind encompasses the investigation of a sample derived from a biological source, in which method a signal generated by coherent anti-Stokes Raman scattering by excitation of resonance sites in the sample by means of laser irradiation is sensed in image-producing fashion, and in which structural properties of the chemical structures containing the resonance sites can also optionally be derived from the signal.

When a “sample derived from a biological source” is referred to in the context of the present invention, this can involve a sample removed directly from a biological system, for example an animal tissue sample, a plant structure, and/or a prepared specimen derived therefrom. The present invention can also be utilized, however, in more or less highly processed samples, for example in food chemistry. The present invention is especially suitable, for example, for purity checking, for example of oils.

The invention is of course particularly suitable for tagging in biological samples, for example nerve tissue, in which the intelligence of a tag can be combined with the specificity of vibrational spectroscopy. It thus becomes possible, for example, simultaneously to check lipids for tags and to process them in image-producing fashion; these could previously only be sensed separately.

The structural properties of the chemical structures encompassing the resonance sites can be derived in known fashion from the signal generated by coherent anti-Stokes Raman scattering. A corresponding signal, which for example can also be obtained in the form of spectra when tunable Stokes light beams are used, contains features, for example corresponding wavelengths, bands, and/or peaks, that are specific for the respectively contained resonance sites, in particular the respective chemical bonds. These are indicated as Raman shifts or CARS shifts (which correspond to the frequency differences between the respective molecular vibration states), typically in the form of wave numbers. One skilled in the art may gather characteristic wavelengths obtained for chemical bonds from relevant reference works.

The present invention is also suitable for the use of Stokes light beams of fixed wavelength. Although spectra are not acquired in this case, the signal generated by coherent anti-Stokes Raman scattering can be used in this case as well for image production.

A method of this kind thus encompasses, according to the present invention, the furnishing of at least one resonance site by means of a bioorthogonal reaction of an intrinsic chemical structure of the sample with at least one further reaction partner, i.e. the introduction, by way of a bioorthogonal reaction, of a corresponding structure that is not inherently contained in the sample.

The term “bioorthogonal reaction” will be further explained in detail below. The term “intrinsic chemical structure” is understood here as a chemical structure that is already contained in the sample as a result of its origin. In samples deriving from biological sources this refers, for example, to aliphatic chains having corresponding bonds in lipids, peptide bonds in proteins, and the like. Intrinsic chemical structures of this kind comprise resonance sites that can be sensed in image-producing fashion using CARS microscopy.

In contrast to such intrinsic resonance sites, or the chemical structures on which they are based, resonance sites introduced according to the present invention into a sample are those that the sample does not comprise based on its natural origin. The invention thus makes it possible to equip a sample that inherently does not possess, or does not possess sufficient, resonance sites, or in which the resonance sites do not exhibit the desired localization or specificity, with corresponding resonance sites.

According to the present invention provision can be made either that the at least one resonance site is at least partly part of the at least one further reaction partner, and/or that said site is generated at least partly by the bioorthogonal reaction itself. The former case corresponds fundamentally to conventional staining reactions and/or tagging reactions with fluorescent dyes. Here, as a rule, a fluorescent or color-imparting structure is furnished in a corresponding molecule, and is coupled to reactive structures of the sample. In contrast thereto, however, utilization of the method according to the present invention also makes it possible to generate resonance sites in the context of performance of the bioorthogonal reaction itself.

This can be accomplished, for example, by cycloaddition of a conjugated diene to a dienophile (which can have a double or triple bond), as illustrated below:

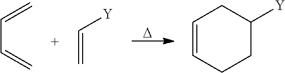

If, for example, the residue Y is used here as a coupling site, it is possible to generate, for addition and complete reaction of a suitable diene, a structure that is depicted on the right in the reaction equation above and exhibits, because of its specific properties, a well-defined CARS pattern to which a subsequent detection process can be matched.

As mentioned, the method according to the present invention can also be used in particular to highlight or make visible chemical structures normally not detectable by means of CARS microscopy.

The present invention makes it possible in particular, once the resonance sites have been created by means of the bioorthogonal reaction, to use small molecules that can be introduced deep into a corresponding tissue, since no steric hindrance occurs and, for example, they diffuse through a tissue. This is a substantial advantage in the context of the use of bioorthogonal reactions as compared with conventional staining techniques, for example using fluorescent dyes. This type of introduction into tissue is of particular interest because, as mentioned, three-dimensional image production is possible by means of CARS microscopy.

As mentioned, the present invention is based on the use of bioorthogonal chemical reactions. “Bioorthogonal reactions” are understood in the context of the present Application as chemical reactions that can proceed in living systems without appreciably interfering with natural processes. Bioorthogonal reactions can in particular proceed with no cell-damaging effects.

The term “bioorthogonality” and the chemical reactions relevant here are known to those skilled in the art (see E. M. Sletten and C. R. Bertozzi, “Bioorthogonal chemistry, or: Fishing for selectivity in a sea of functionality” [Bioorthogonale Chemie-oder: in einem Meer aus Funktionalität nach Selektivität fischen], Angew. Chem. 121 (38), 7108-7133, 2009, concurrently E. M. Sletten and C. R. Bertozzi, “Bioorthogonal Chemistry: Fishing for Selectivity in a Sea of Functionality,” Angew. Chem. Int. Ed. Engl. 48 (38), 6974-6998, 2009). An overview is also provided by K. V. Reyna and Q. Lin, “Bioorthogonal Chemistry: Recent Progress and Future Directions,” Chem. Commun. (Camb.) 46(10), 1589-1600, 2010.

Typical bioorthogonal reactions encompass, for example, 1,3-dipolar cycloaddition between azides and cyclooctynes (so-called “copper-free click chemistry,” see J. M. Baskin et al., “Copper-Free Click Chemistry for Dynamic In Vivo Imaging,” Proc. Natl. Acad. Sci. USA 104 (43), 16793-16797, 2007). Other typical reactions are the reaction between nitrones and the aforesaid cyclooctynes, oxime/hydrate formation from aldehydes and ketones, tetrazine reactions, isonitrile-based click reactions, and quadricyclane formation.

A Diels-Alder reaction and/or a Staudinger ligation are considered particularly advantageous for use in the bioorthogonal reaction according to the present invention. Staudinger ligation is a highly chemoselective method for producing bioconjugates. The respective reaction partners are bioorthogonal to almost all functional groups present in biological systems, and already react in an aqueous environment at room temperature. This allows Staudinger ligation to be used even in the complex surroundings of a living cell. Reference is made, regarding details, to the relevant technical literature (see e.g. S. Sander et al., “Staudinger Ligation as a Method for Bioconjugation,” Angew. Chem. Int. Ed. Engl. 50 (38), 8806-8827, 2011).

The use of bioorthogonal reactions typically encompasses two steps. Firstly a cellular substrate, i.e. in this case the sample to be investigated, is equipped with a bioorthogonal functional group that is introduced into the sample and is also referred to as a “chemical reporter.” Substrates that are used include, for example, metabolites, enzyme inhibitors, etc., and in the context of the present invention all compounds or tissues that are to be tagged and for which improved visualization in CARS microscopy is desired. The bioorthogonal functional group, also referred to as a chemical reporter, must not substantially modify the structure of the sample, so as not to negatively affect bioactivity. In a second step a tagging substance, having a complementary functional group that reacts with the chemical reporter, is introduced.

The use of bioorthogonal reactions in combination with CARS microscopy makes possible dedicated detection of target sites in any samples, for example in cells, without negatively affecting biochemical processes that may continue to occur. Subsequently thereto, the tagging reaction causes the actual synthesis or introduction of the “active” substance for CARS image production.

This method allows the CARS-active scattering cross section of the respective target to be increased, or to be generated in the first place by suitable synthesis reactions. A corresponding method combines, by way of chemical image production, the advantage of known multi-photon techniques with a corresponding selective reaction. Especially as compared with the conventional use of fluorescent dyes as image-producing elements (e.g. for single-photon methods), target sites located deeper in the tissue can be utilized for image production thanks to the advantageous steric properties of the compounds used in the bioorthogonal reactions.

A further advantage that can be obtained by way of the features proposed according to the present invention is, as mentioned, a reproducible counter-staining of the non-resonant background in the context of CARS microscopy.

As mentioned, CARS methods generally take into account a non-resonant background that can conventionally also be used as a “counter-stain.” This has the disadvantage, however, that the background is statistical. With the features proposed according to the present invention, on the other hand, a defined background can be introduced by way of a corresponding actively performed “counter-stain,” so that specific molecules can be targeted and the resulting image can be correlated with the background that has been generated. This enables an improvement in the reproducibility of corresponding CARS methods, as well as improved quantitative conclusions.

As is generally known, conventional Raman methods are not overly sensitive and require strong Raman scatterers. CARS microscopy is substantially more sensitive, although it cannot be used like Raman spectroscopy in highly specific complex substance mixtures. In some circumstances this lower specificity is not sufficient for the task on which the investigative method is based. The invention, on the other hand, allows a corresponding increase in specificity and additionally an increase in scattering cross section when the latter is necessary.

Particularly advantageous examples of bioorthogonal reactions in the context of the present invention encompass at least one reaction step in the form of a modified Huisgen cycloaddition, a nitrone dipolar cycloaddition, a norbornene cycloaddition, a (4+1) cycloaddition, and/or an oxanorbornadiene cycloaddition.

The aforementioned copper-free click reactions are particularly suitable for use in the context of the present invention, for example utilizing cyclooctynes. The cyclooctynes are, for example, coupled to an azide group that can in turn be introduced into a corresponding sample as a first reaction partner. Azide groups are bioorthogonal in particular because they are small, and can thus penetrate easily into the corresponding tissue and not produce any steric changes. Azides do not occur in natural samples, so that no competing secondary biological reactions exist (see M. F. Debets et al., “Azide: a unique dipole for metal-free bioorthogonal ligations,” Chembiochem. 11(9), 1168-84, 2010). Cyclooctynes are larger, but they have sufficient stability and orthogonality that they too are suitable for in vivo tagging.

A tetrazine reaction, a tetrazole reaction, and/or a quadricyclane reaction can also, in particular, be used in the context of the present invention as at least one reaction step of the bioorthogonal reaction. Such reactions are also known in principle.

As already explained repeatedly, the at least one intrinsic structure of the sample can firstly be coupled to a first reaction partner, and the reaction partner coupled to the intrinsic structure of the sample can then be coupled to a further reaction partner. Any reaction partner can encompass the resonance site, or the latter can be formed only by a reaction among any two or more reaction partners.

A method in which a structure of the sample which does not intrinsically have a resonance site is equipped with a resonance site by means of the bioorthogonal reaction is regarded as particularly advantageous. As explained, this relates in particular to the inherently non-resonant background, which in conventional methods yields statistical signals that are nevertheless not reproducible. The invention, conversely, makes it possible to tag the non-resonant background with corresponding resonance sites and thus to generate a stable, reproducible background signal. The latter is advantageously generated by selecting suitable compounds in such a way that it stands out in contrasting fashion from the structures that are actually of interest, for example exhibits peaks at distinctly different wavelengths.

A corresponding method can encompass furnishing resonance sites for the structures of the non-resonant background of the sample, and correlating a signal component of the resonance signal attributable to those resonance sites with a signal component attributable to intrinsic resonance sites of the sample.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described in detail below with reference to the drawings.

### DESCRIPTION OF THE FIGURES

FIG. 1 schematically illustrates a CARS microscope that can be used in a method according to an embodiment of the invention.

FIG. 2 shows a term diagram of a CARS transition that can be the basis of an embodiment of the invention.

FIG. 3 illustrates a four-wave mixing process that can be the basis of an embodiment of the invention.

FIG. 4 illustrates a method according to an embodiment of the invention in accordance with a schematic diagram.

FIG. 5 illustrates a method according to an embodiment of the invention in accordance with a schematic diagram.

FIG. 6 illustrates a method according to an embodiment of the invention in accordance with a schematic flow chart.

In the Figures, elements that correspond to one another are labeled with identical reference characters and are not repeatedly explained.

### DETAILED DESCRIPTION OF THE INVENTION

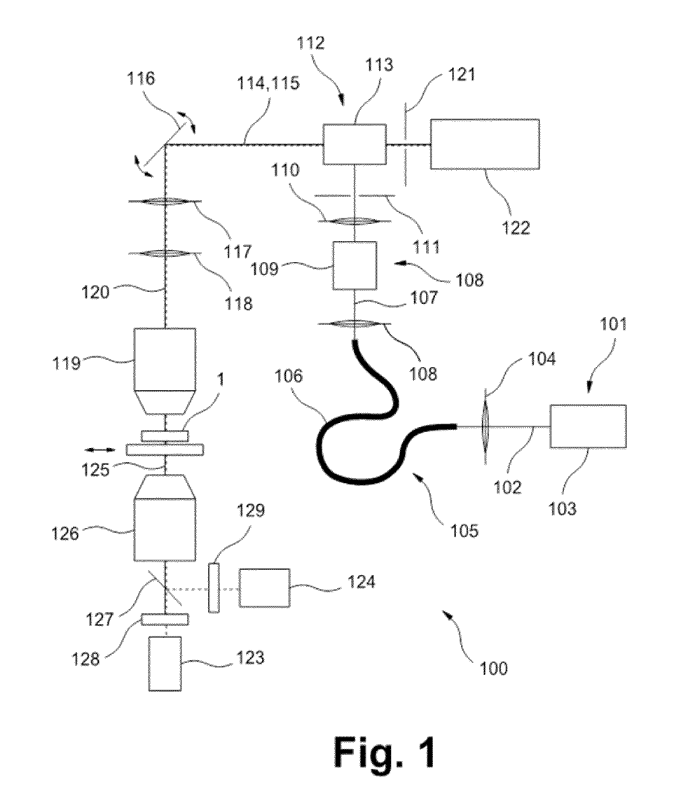

FIG. 1 shows a microscope, embodied as confocal scanning microscope 100, that contains a laser 101 for generating a light beam 102 of a first wavelength of, for example, 800 nm. Laser 101 can be embodied as a mode-coupled titanium-sapphire laser 103. Light beam 102 is focused with an incoupling optic 104 into the end of a, for example, microstructured optical element 105 for wavelength modification, which element can be embodied as a light-guiding fiber made of photonic band gap material 106.

An outcoupling optic 108 is provided, for example, in order to collimate the wavelength-broadened light beam 107 that emerges from the light-guiding fiber made of photonic band gap material 106. The spectrum of the correspondingly wavelength-modified light beam is as a result, for example, almost continuous over the wavelength region from 300 nm to 1600 nm, the light power level being largely constant over the entire spectrum.

Wavelength-broadened light beam 107 passes through a suppression means 108, for example a dielectric filter 109, that, in wavelength-broadened light beam 107, reduces the power level of the light component in the region of the first wavelength to the level of the other wavelengths of wavelength-broadened light beam 107. Wavelength-modified light beam 107 is then focused, for example with an optic 110, onto an illumination pinhole 111, and then arrives at a selection means 112 that is embodied as an acousto-optical component 113 and functions as a main beam splitter. A pump light beam 114 and a Stokes light beam 115, each having a wavelength defined by a user, can be selected with selection means 112.

From selection means 112, pump light beam 114 and Stokes light beam 115, which proceed coaxially, travel to a scanning mirror 116 that guides them through a scanning optic 117, a tube optic 118, and an objective 119 and over a sample 1. Detected light 120 emerging from sample 1, which light is depicted in the drawing with dashed lines, travels (when, for example, descanned detection is provided) back through objective 119, tube optic 118, and scanning optic 117 to scanning mirror 116 and then to selection means 112, passes through the latter, and after traversing a detection pinhole 121 is detected with a detector 122 that is embodied as a multi-band detector. When, for example, non-descanned detection is likewise provided, two further detectors 123, 124 can be provided on the condenser side. Detected light 125 emerging in a straight-ahead direction from the sample is collimated by a condenser 126 and distributed by a dichroic beam splitter 127, as a function of wavelength, to further detectors 123, 124. Filters 128, 129 are provided in front of the detectors in order to suppress those components of the detected light which have the wavelengths of pump light beam 114 or of Stokes light beam 115, or of other light.

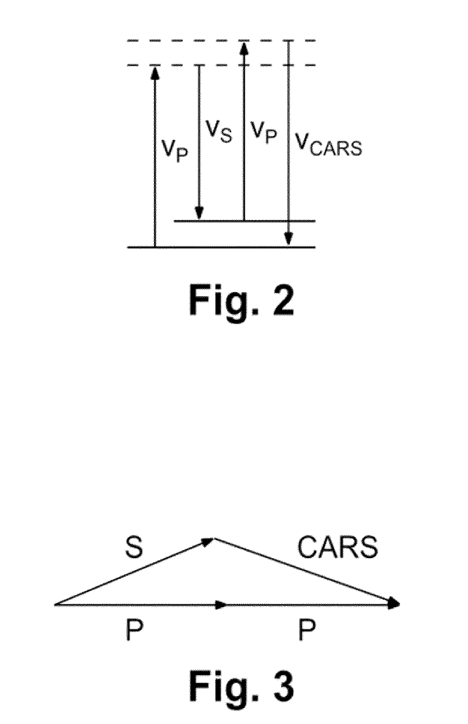

FIGS. 2 and 3 have already been referred to in the introductory section.

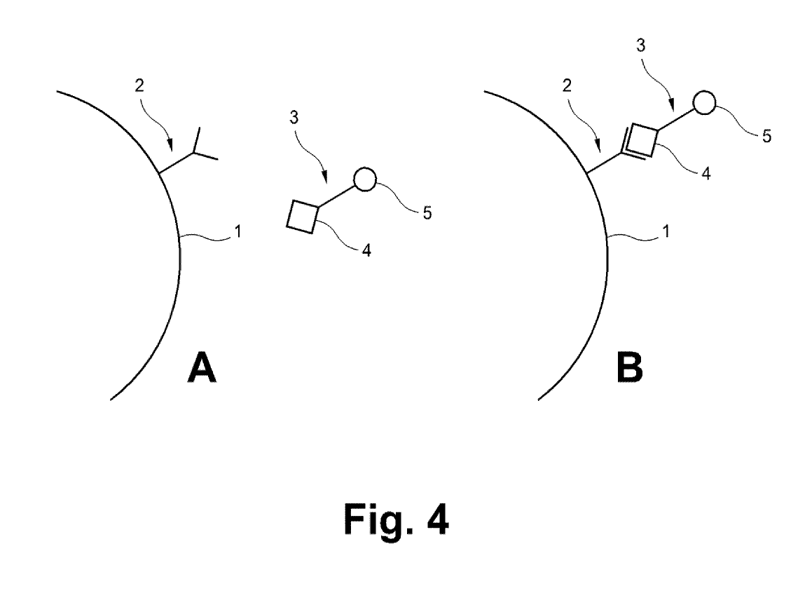

FIG. 4 shows, in the respective partial figures A and B, a sample 1 derived from a biological source. Sample 1 can be, for example, a cell to be tagged and/or a surface of a microscopic section and/or a correspondingly prepared tissue sample.

In the example depicted, sample 1 comprises an intrinsic chemical structure, labeled 2, that is capable of coupling with a reaction partner, here labeled 3. In the example depicted, reaction partner 3 encompasses a coupling site 4 and a resonance site 5 that, upon excitation by means of laser irradiation, can produce a resonance signal as a result of coherent anti-Stokes Raman scattering.

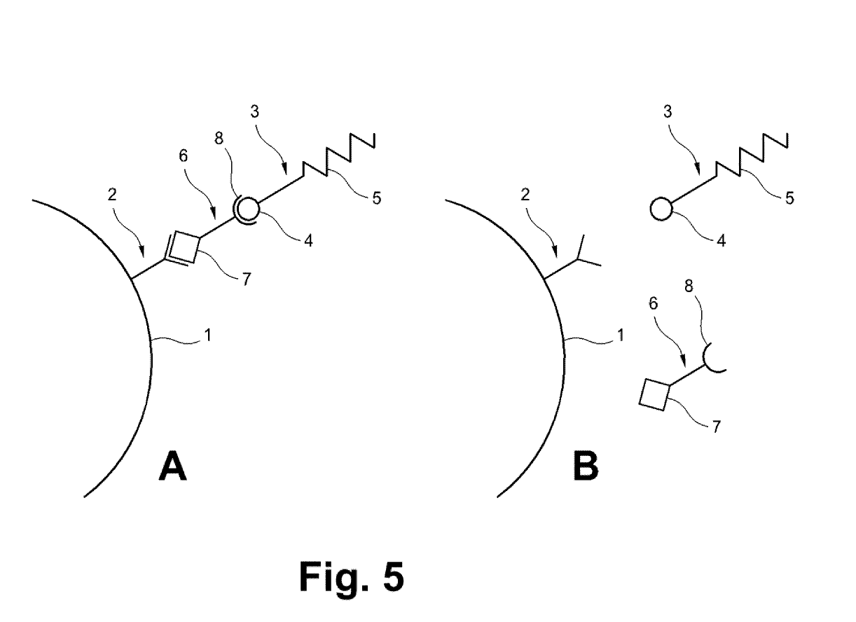

Figure detail A of FIG. 4 shows a non-coupled state between intrinsic chemical structure 2 of sample 1 and reaction partner 3. Partial figure B, on the other hand, illustrates a coupled state, the result of which is that resonance site 5 of reaction partner 3 can now be used as part of sample 1 for detection.

Whereas FIG. 4 and its parts A and B show a single-stage reaction, FIG. 5 illustrates a two-stage reaction. In this, intrinsic chemical structure 2 is firstly coupled to a coupler molecule 6 that comprises a first functional group 7 for coupling to intrinsic chemical structure 2 of sample 1, and a second functional group 8 for coupling to reaction partner 3 that carries resonance site 5. Intrinsic chemical structure 2 of sample 1 couples here to first functional group 7 of coupler molecule 6; reaction partner 3 couples with its coupling site 4 to second functional group 8 of coupler molecule 6. Coupling sites 4 and resonance sites 5 that are in part drawn differently in FIGS. 4 and 5 serve only for illustration. According to FIG. 5 as well, resonance site 5 becomes part of sample 1 and can correspondingly be detected. Unlike in FIG. 4, however, partial figure A here shows a coupled state, and partial figure B an uncoupled state.

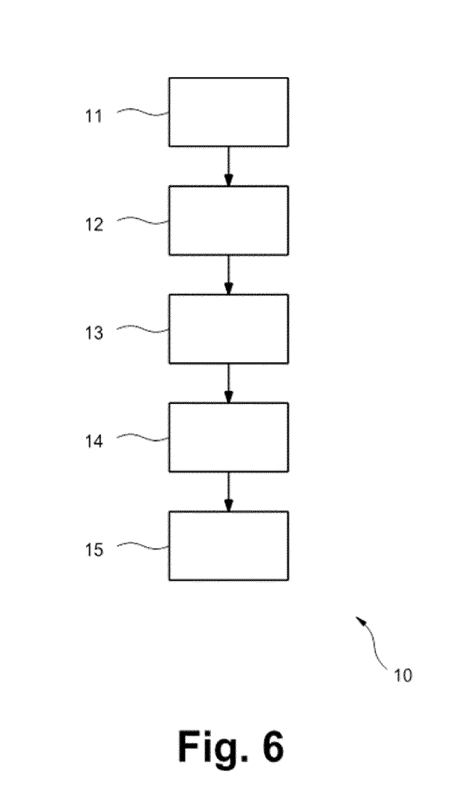

In FIG. 6 a method according to an embodiment of an invention is depicted in the form of a schematic flow chart and is labeled 10 in its entirety. The method begins in a method step 11 with the furnishing of a sample 1. In a method step 12 a bioorthogonal reaction of an intrinsic chemical structure of the sample with at least one further reaction partner is carried out. In a step 13 the sample, having the resonance site that has been furnished by means of the bioorthogonal reaction in step 12, is introduced into a suitable investigation system, for example a CARS microscope according to FIG. 1. In step 14 an investigation of the sample is performed in the investigation system. A correspondingly obtained signal is sensed in a step 15 and used, for example, to derive at least one structural property of a chemical structure containing the at least one resonance site.

1. A method for investigating a sample, derived from a biological source, using CARS microscopy, in which method a resonance signal generated by coherent anti-Stokes Raman scattering by excitation of at least one resonance site of the sample by means of laser irradiation is sensed in image-producing fashion,
wherein the method comprises furnishing at least one resonance site by means of a bioorthogonal reaction of an intrinsic chemical structure of the sample with at least one reaction partner.

2. The method according to claim 1, in which the resonance site is at least partly part of the at least one reaction partner and/or is generated at least partly by the bioorthogonal reaction.

3. The method according to claim 1, in which at least one of a Diels-Alder reaction and a Staudinger ligation is used as at least one reaction step of the bioorthogonal reaction.

4. The method according to claim 1, in which at least one of a modified Huisgen cycloaddition, a nitrone dipolar cycloaddition, a norbornene cycloaddition, a (4+1) cycloaddition, and an oxanorbornadiene cycloaddition is used as at least one reaction step of the bioorthogonal reaction.

5. The method according to claim 1, in which at least one of a tetrazine reaction, a tetrazole reaction, and a quadricyclane reaction is used as at least one reaction step of the bioorthogonal reaction.

6. The method according to claim 1, in which the at least one intrinsic structure of the sample is firstly coupled to a first reaction partner, and the reaction partner coupled to the intrinsic structure of the sample is then coupled to a further reaction partner.

7. The method according to claim 6, in which the further reaction partner encompasses comprises the resonance site.

8. The method according to claim 1, which comprises, for a structure of the sample (1) not intrinsically comprising a resonance site, furnishing a resonance site by means of the bioorthogonal reaction.

9. The method according to claim 1, in which at least one structural property of a structure containing the at least one resonance site is derived from the resonance signal.

10. The method according to claim 1, in which intrinsic structures of a non-scattering background of the sample are equipped with resonance sites, and a signal component of the resonance signal attributable to those resonance sites is correlated with a signal component attributable to intrinsic resonance sites.
